(19) United States
(12) Patent Application Publication
(10) Pub. No.: US 2026/0202876 A1
(43) Pub. Date: Jul. 16, 2026

(54) Touch Sensitive Display Assembly with a Three-Dimensional Display Cover

(71) Applicant: Google LLC, Mountain View, CA (US)

(72) Inventors: Gang Cheng, Burlingame, CA (US); Choongho Lee, San Diego, CA (US)

(21) Appl. No.: 18/865,628

(22) PCT Filed: Jun. 30, 2022
(86) PCT No.: PCT/US2022/035736

§ 371 Date: Nov. 13, 2024

(51) Int. Cl. G06F 1/16; G04G 17/04; G06F 3/044

(52) U.S. Cl. CPC G06F 1/1643; G04G 17/045; G06F 1/163; G06F 3/0446; G06F 2200/1634

(57) ABSTRACT

A touch sensitive display assembly is provided. The touch sensitive display assembly includes a three-dimensional display cover defining an internal volume. The three-dimensional display cover includes a central portion and a peripheral portion. The peripheral portion extends around a periphery of the internal volume. The touch sensitive display assembly includes a display panel positioned within an internal volume defined by a three-dimensional display cover having a central portion and a peripheral portion extending around a periphery of the internal volume. The touch sensitive display further includes a first plurality of touch sensors operable to detect a touch input provided at the central portion of the three-dimensional display cover and a second plurality of touch sensors operable to detect a touch input provided at the peripheral portion of the three-dimensional display cover. and a second plurality of touch sensors.

### FIELD

The present disclosure relates generally to touch sensitive displays. More particularly, the present disclosure relates to a touch sensitive display assembly with a three-dimensional display cover.

### BACKGROUND

Touch sensitive displays can be included in various types of electronic devices (e.g., smartwatches, smartphones, thermostats). Electronic devices having a touch sensitive display can include a display cover to protect the touch sensitive display from being damaged (e.g., scratched or cracked). The display cover can be formed from a transparent material (e.g., glass). In this manner, a user can view the touch sensitive display through the display cover.

### SUMMARY

Aspects and advantages of embodiments of the present disclosure will be set forth in part in the following description, or can be learned from the description, or can be learned through practice of the embodiments.

In one aspect, a touch sensitive display assembly is provided. The touch sensitive display assembly includes a three-dimensional cover defining an internal volume. The three-dimensional cover includes a central portion and a peripheral portion. The peripheral portion extends around a periphery of the internal volume. The touch sensitive display assembly further includes a first plurality of touch sensors operable to detect a touch input provided at the central portion of the three-dimensional display cover and a second plurality of touch sensors operable to detect a touch input provided at the peripheral portion of the three-dimensional display cover.

In some embodiments, each of the second plurality of touch sensors is positioned on the peripheral portion of the three-dimensional display cover.

In some embodiments, the second plurality of touch sensors are spaced apart from one another along a circumferential direction of the three-dimensional display cover.

In some embodiments, each of the first plurality of touch sensors is included within a first layer of a plurality of layers of the display panel.

In some embodiments, each of the first plurality of touch sensors is positioned on the central portion of the three-dimensional display cover.

In some embodiments, the touch sensitive display assembly further includes a controller, a first plurality of conductors, and a second plurality of conductors. Each of the first plurality of conductors electrically couples the controller to a corresponding touch sensor of the first plurality of touch sensors. Each of the second plurality of touch sensors electrically couples the controller to a corresponding touch sensor of the second plurality of touch sensors.

In some embodiments, at least a portion of the first plurality of conductors and the second plurality of conductors is disposed on the peripheral portion of the three-dimensional display cover.

In some embodiments, at least one of the first plurality of touch sensors or the second plurality of touch sensors is deposited on a surface of the three-dimensional display cover.

In another aspect, a wearable computing device is provided. The wearable computing device includes a housing and a touch sensitive display assembly. The touch sensitive display includes a three-dimensional display cover. The three-dimensional display cover is positioned on the housing and defines an internal volume. The three-dimensional display cover includes a central portion and a peripheral portion extending around a periphery of the internal volume. The wearable computing device further includes a display panel at least partially positioned within the internal volume defined by the three-dimensional display cover. The touch sensitive display assembly further includes a first plurality of touch sensors operable to detect a touch input provided at the central portion of the three-dimensional display cover and a second plurality of touch sensors operable to detect a touch input provided at the peripheral portion of the three-dimensional display cover.

In some embodiments, each of the second plurality of touch sensors is positioned on the peripheral portion of the three-dimensional display cover.

In some embodiments, each of the second plurality of touch sensors is positioned on the peripheral portion of the three-dimensional display cover.

In some embodiments, each of the second plurality of touch sensors is positioned on a region of an interior surface of the three-dimensional display cover that corresponds to the peripheral portion of the three-dimensional display cover.

In some embodiments, the touch sensitive display assembly further includes a controller, a first plurality of conductors, and a second plurality of conductors. Each of the first plurality of conductors electrically couples the controller to a corresponding touch sensor of the first plurality of touch sensors. Each of the second plurality of touch sensors electrically couples the controller to a corresponding touch sensor of the second plurality of touch sensors.

In some embodiments, the touch sensitive display assembly further includes a plurality of conductors, each of the plurality of conductors coupling a corresponding touch sensor of the second plurality of touch sensors to a flexible printed circuit board disposed within a cavity defined by the housing of the wearable computing device.

In some embodiments, the touch sensitive display assembly includes an opaque material positioned between the interior surface of the three-dimensional display cover and the plurality of conductors.

In some embodiments, the three-dimensional display cover defines a circumferential direction and the second plurality of touch sensors are spaced apart from one another along the circumferential direction. In some embodiments, the three-dimensional display cover includes a glass material. In some embodiments, the central portion of the three-dimensional display cover is flat and the peripheral portion of the three-dimensional display cover is arcuate.

In some embodiments, a total number of touch sensors included in the first plurality of touch sensors is different than a total number of touch sensors included in the second plurality of touch sensors.

In some embodiments, at least one of the first plurality of touch sensors or the second plurality of touch sensors includes a capacitive sensor.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a wearable computing device according to an embodiment of the present disclosure.

FIG. 2 depicts a cross-sectional view of a wearable computing device according to an embodiment of the present disclosure.

FIG. 3 depicts an exploded view of a wearable computing device according to an embodiment of the present disclosure.

FIG. 4 depicts a cross-sectional view of a three-dimensional display cover for a display of a wearable computing device.

FIG. 5 depicts a block diagram of components of a touch sensitive display assembly according to an embodiment of the present disclosure.

FIG. 6A depicts the touch sensitive display assembly of FIG. 5 according to a first embodiment of the present disclosure.

FIG. 6B depicts the touch sensitive display assembly of FIG. 5 according to a second embodiment of the present disclosure.

FIG. 6C depicts the touch sensitive display assembly of FIG. 5 according to a third embodiment of the present disclosure.

FIG. 7 depicts an arrangement of touch sensors of a touch sensitive display on a three-dimensional display cover according to an embodiment of the present disclosure.

FIG. 8 depicts a touch sensor of a touch sensitive display deposited on a surface of a three-dimensional display cover according to an embodiment of the present disclosure.

FIG. 9 depicts a connection between a printed circuit board and conductors of a touch sensitive display assembly according to an embodiment of the present disclosure.

FIG. 10 depicts a block diagram of components of a computing system of a wearable computing device according to an embodiment of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

The present disclosure is directed to electronic devices having a three-dimensional display cover for a touch sensitive display panel. The three-dimensional display cover defines an internal volume in which the touch sensitive display panel is at least partially positioned to protect the touch sensitive display panel from being damaged (e.g., scratched or cracked). Furthermore, the three-dimensional display cover includes a central portion and a peripheral portion. The central portion is positioned above the touch sensitive display. More particularly, the central portion is positioned directly above the touch sensitive display panel. In some embodiments, the central portion positioned directly above the touch sensitive display panel is flat.

The peripheral portion extends around the periphery of the internal volume. However, since touch sensitive display panels are either on-cell displays or in-cell displays, a user must touch the three-dimensional display cover at a specific location to provide a touch input for the touch sensitive display panel. More particularly, the user must touch the central portion of the three-dimensional display cover to provide a touch input for the touch sensitive display panel. Stated another way, the user cannot provide a touch input by touching the peripheral portion of the three-dimensional display cover.

Example aspects of the present disclosure are directed to a touch sensitive display assembly. The touch sensitive display assembly includes the three-dimensional cover. The touch sensitive display assembly further includes a display panel at least partially positioned within the internal volume of the three-dimensional cover. The display panel includes a plurality of layers (e.g., display layer, glass layer). The touch sensitive display assembly further includes a first plurality of touch sensors operable to detect a touch input provided at the central portion of the three-dimensional display cover and a second plurality of touch sensors operable to detect a touch input provided at the peripheral portion of the three-dimensional display cover. Details of the first plurality of touch sensors and the second plurality of touch sensors will now be discussed.

In some embodiments, the first plurality of touch sensors are included within the touch sensitive display panel. For instance, the first plurality of touch sensors can be included in a first layer (e.g., touch layer) of the plurality of layers of the display panel. In some embodiments, the first layer can be a top-most layer of the display panel. In alternative embodiments, the first layer can be positioned beneath one or more other layers (e.g., polarizer layer, glass layer, etc.) of the display panel.

In some embodiments, the first plurality of touch sensors are positioned on the three-dimensional display cover. For instance, in some embodiments, the first plurality of touch sensors can be positioned on an interior surface of the three-dimensional display cover. As used herein, the “interior surface” of the three-dimensional display cover refers to a surface that faces the internal volume of the three-dimensional display cover. Furthermore, in embodiments in which the first plurality of touch sensors are positioned on the interior surface of the three-dimensional display cover, it should be understood that the first plurality of touch sensors are positioned on a region of the interior surface that corresponds to the central portion of the three-dimensional display cover.

In some embodiments, the first plurality of touch sensors are positioned on an exterior surface of the three-dimensional display cover. As used herein, the “exterior surface” of the three-dimensional display cover refers to a surface that does not face the internal volume of the three-dimensional display cover. In embodiments in which the first plurality of touch sensors are positioned on the exterior surface of the three-dimensional display cover, it should be understood that the first plurality of touch sensors are positioned on a region of the exterior surface that corresponds to the central portion of the three-dimensional display cover.

The second plurality of sensors are positioned on the peripheral portion (e.g., bezel) of the three-dimensional display cover. In this manner, the touch sensitive display assembly of the present disclosure can detect touch input that is provided by a user touching the peripheral portion of the three-dimensional display cover. In some embodiments, the second plurality of touch sensors are positioned on the interior surface of the three-dimensional display cover. In such embodiments, it should be understood that the second plurality of touch sensors are positioned on a region of the interior surface that corresponds to the peripheral portion of the three-dimensional display cover. In alternative embodiments, the second plurality of touch sensors are positioned on the exterior surface of the three-dimensional display cover. In such embodiments, the second plurality of touch sensors are positioned on a region of the exterior surface that corresponds to the peripheral portion of the three-dimensional display cover.

It should be appreciated that the first plurality of touch sensors and the second plurality of touch sensors can be deposited on the three-dimensional display cover, specifically the interior surface or exterior surface thereof, in any suitable manner. For instance, in some embodiments, the first plurality of touch sensors, the second plurality of touch sensors, or both can be deposited on a surface (e.g., interior surface, exterior surface) of the three-dimensional display cover via a sputtering process.

The touch sensitive display assembly includes a controller (e.g., one or more processors) electrically coupled to the plurality of touch sensors (e.g., first plurality of touch sensors and second plurality of touch sensors). For instance, the touch sensitive display can include a first plurality of conductors electrically coupling the controller to the first plurality of touch sensors and a second plurality of conductors electrically coupling the controller to the second plurality of touch sensors.

In some embodiments, each of the first plurality of conductors electrically couples the controller to a corresponding touch sensor of the first plurality of touch sensors. In addition, each of the second plurality of conductors electrically couples the controller to a corresponding touch sensor of the second plurality of touch sensors. In alternative embodiments, each of the first plurality of first conductors electrically couples the controller to multiple of the first plurality of touch sensors. In addition, each of the plurality of second conductors electrically couples the controller to multiple of the second plurality of touch sensors. In such embodiments, a total number of conductors needed to electrically couple the controller to the first plurality of touch sensors can be less than a total number of the first plurality of conductors. Likewise, a total number of conductors needed to electrically couple the controller to the second plurality of touch sensors can be less than the total number of the second plurality of touch sensors.

In some embodiments, a portion of the second plurality of conductors is disposed on the region of the interior surface of the three-dimensional display cover that corresponds to the peripheral portion of the three-dimensional display cover. Furthermore, in such embodiments, the interior surface of the three-dimensional display cover can be covered in an opaque material (e.g., black ink). In this manner, the portion of the conductors that is disposed on the region of the interior surface corresponding to the peripheral portion of the three-dimensional display cover can be hidden from view of the user.

In some embodiments, one or more of the first plurality of conductors can be sputtered to the corresponding touch sensor of the first plurality of touch sensors. Alternatively, or additionally, one or more of the second plurality of conductors can be sputtered to the corresponding touch sensor of the of the second plurality of touch sensors. It should be understood that the conductors can be attached to the touch sensors in any suitable manner. For instance, in some embodiments, the conductors are deposited on the touch sensors via a silver paste. In some embodiments, the silver paste can be transparent. Furthermore, in some embodiments, the silver paste can be used to couple the conductors to a printed circuit on which the controller of the touch sensitive display assembly is located.

In some embodiments, the second plurality of touch sensors can be spaced apart along a circumferential direction of the three-dimensional display cover. Furthermore, in some embodiments, the second plurality of touch sensors can be evenly spaced apart from one another along the circumferential direction. In this manner, a touch signal indicative of one or more of the second plurality of touch sensors detecting the user touching the peripheral portion of the three-dimensional display cover can be more uniform.

In some embodiments, a total number of touch sensors included in the first plurality of touch sensors can be different than a total number of touch sensors included in the second plurality of touch sensors. In alternative embodiments, the total number of touch sensors included in the first plurality of touch sensors can be equal to the total number of touch sensors included in the second plurality of touch sensors.

In some embodiments, the first plurality of touch sensors can be arranged on the central portion of the three-dimensional cover according to a first pattern (e.g., rectangle).

Furthermore, the second plurality of touch sensors can be arranged on the peripheral portion of the three-dimensional cover according to a second pattern (e.g., ring) that is different than the first pattern. It should be understood that the patterns (e.g., first pattern, second pattern) can correspond to a shape of the corresponding portion (e.g., central, peripheral) of the three-dimensional display cover. In this manner, the touch sensors can be deposited on the three-dimensional display cover so that touch input can be detected regardless of where the user touches the three-dimensional display cover.

An electronic device having a touch sensitive display assembly according to the present disclosure can provide numerous technical effects and benefits. For instance, the touch sensitive display having touch sensors positioned on the peripheral portion (e.g., bezel) of the three-dimensional display cover allows the user to provide touch input at a location other than the central portion of the three-dimensional display cover. Furthermore, a touch sensitive display according to the present disclosure can eliminate the need for the electronic device to have separate input devices (e.g., mechanical buttons) since functions associated with the separate input devices can be accommodated by touch input provided at the peripheral portion of the three-dimensional display cover.

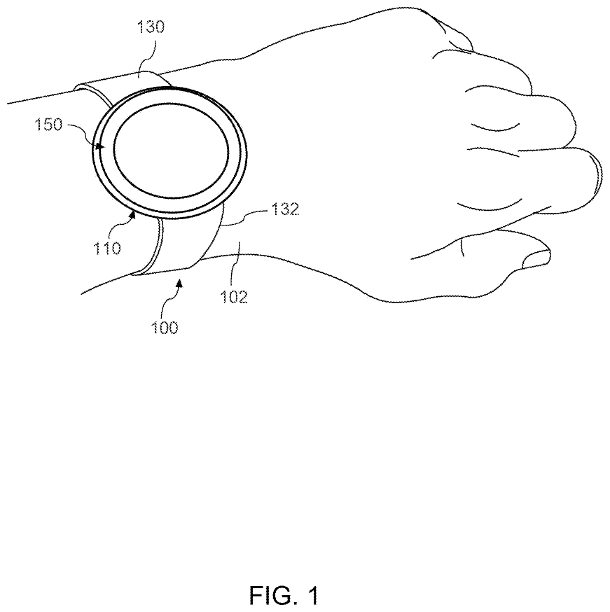

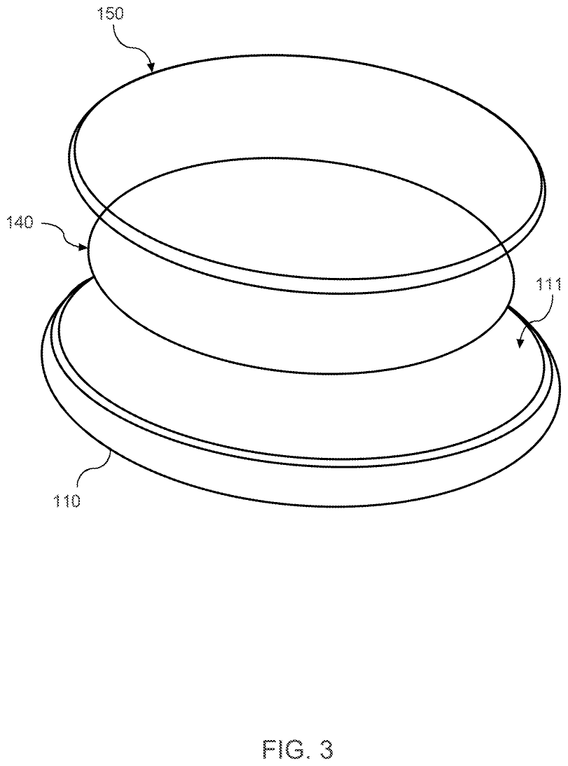

Referring now to the FIGS., FIGS. 1 through 3 depict a wearable computing device 100 according to an embodiment of the present disclosure. As shown, the wearable computing device 100 can be worn, for instance, on an arm 102 (e.g., wrist) of a user. The wearable computing device 100 can include a housing 110 defining a cavity 111 in which one or more electronic components (e.g., disposed on printed circuit boards) are disposed. For instance, the wearable computing device 100 can include a printed circuit board 120 (e.g., flexible printed circuit board) disposed within the cavity 111. Furthermore, one or more electronic components can be disposed on the printed circuit board 120. The wearable computing device 100 can further include a battery (not shown) that is disposed within the cavity 111 defined by the housing 110.

The wearable computing device 100 can include a first band 130 and a second band 132. As shown, the first band 130 can be coupled to the housing 110 at a first location thereon. Conversely, the second band 132 can be coupled to the housing 110 at a second location thereon. Furthermore, the first band 130 and the second band 132 can be coupled to one another to secure the housing 110 to the arm 102 of the user.

In some embodiments, the first band 130 can include a buckle or clasp (not shown). Additionally, the second band 132 can include a plurality of apertures (not shown) spaced apart from one another along a length of the second band 132. In such embodiments, a prong of the buckle associated with the first band 130 can extend through one of the plurality of openings defined by the second band 132 to couple the first band 130 to the second band 132.

It should be appreciated that the first band 130 can be coupled to the second band 132 using any suitable type of fastener. For instance, in some embodiments, the first band 130 and the second band 132 can include a magnet. In such embodiments, the first band 130 and the second band 132 can be magnetically coupled to one another to secure the housing 110 to the arm 102 of the user.

As shown, the wearable computing device 100 includes a display 140. The display 140 can display content (e.g., time, date, biometric, notifications, etc.) for viewing by the user. It should be understood that the display 140 can include any suitable type of display.

For instance, in some embodiments, the display 140 can be an organic light emitting diode (OLED) display.

The wearable computing device 100 can include a cover 150 positioned on top of the display 140. In this manner, the cover 150 can protect the display 140 from being damaged (e.g., scratched or cracked). In some embodiments, the wearable computing device 100 can include a seal (not shown) positioned between the housing 110 and the cover 150. For instance, a first surface of the seal can contact the housing 110 and a second surface of the seal can contact the cover 150. In this manner, the seal between the housing 110 and the cover 150 can prevent a liquid (e.g., water) from entering the cavity 111 defined by the housing 110.

It should be understood that the cover 150 can be optically transparent so that the user can view information being displayed on the display 140. For instance, in some embodiments, the cover 150 can include a glass material. It should be understood, however, that the cover 150 can include any suitable optically transparent material.

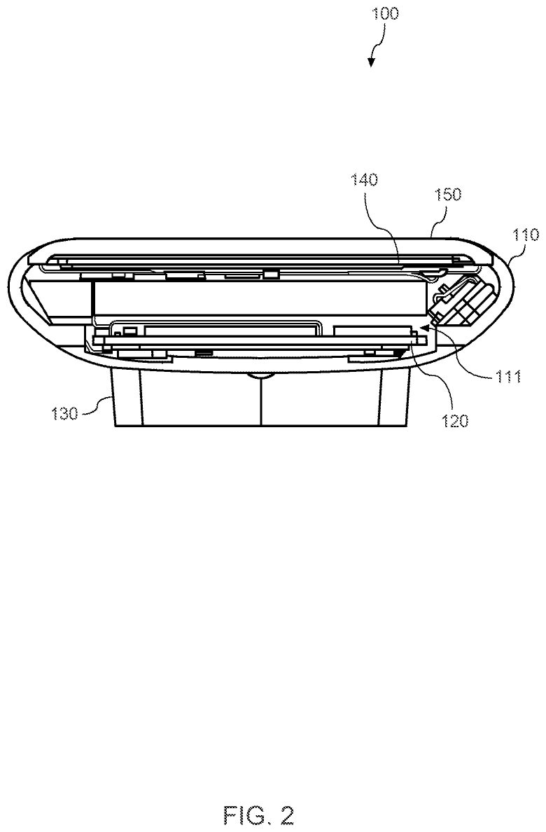

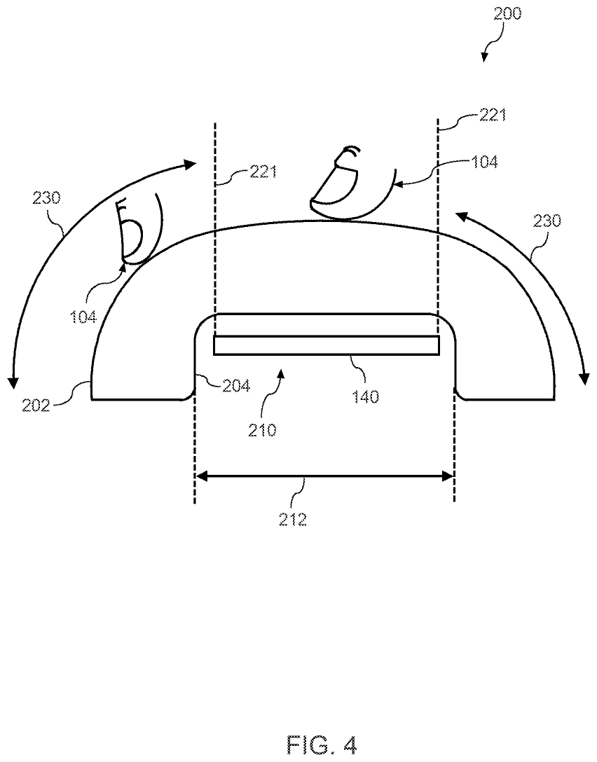

Referring now to FIG. 4, a cross-sectional view of a three-dimensional display cover 200 is provided according to an embodiment of the present disclosure. It should be understood that the three-dimensional display cover 200 can be used to protect the display 140 of the wearable computing device 100 (FIG. 1). More particularly, the three-dimensional display cover 200 can be used in place of the cover 150 discussed above with reference to FIGS. 1 and 2. Details of the three-dimensional display cover 20 will now be discussed in more detail.

The three-dimensional display cover 200 can include an exterior surface 202 and an interior surface 204. Furthermore, the three-dimensional display cover 200 can define an internal volume 210 in which the display 140 is positioned. As shown, the interior surface 204 of the three-dimensional display cover 200 may be shaped to cover the internal volume 210. For example, the interior surface 204 of the three-dimensional display cover three-dimensional display cover 200 can define a recess (e.g., internal volume 210) in which the display 140 is at least partially positioned.

The three-dimensional display cover 200 can include a central portion 220. The central portion 220 includes a region of the three-dimensional display cover 200 that is positioned above the display 140. More particularly, the central portion 220 can be positioned directly above the display 140. Furthermore, a periphery 221 of the central portion 220 of the three-dimensional display cover corresponds (e.g., is the same as) to the periphery of the display 140. In this manner, touch input provided by a user's finger 104 touching the central portion 220 of the three-dimensional display cover 200 can be detected by the display 140.

The three-dimensional display cover 200 further includes a peripheral portion 230. The peripheral portion 230 extends around a periphery 212 of the internal volume 210 of the three-dimensional display cover 200. Stated another way, the peripheral portion 230 of the three-dimensional display cover 200 includes any region of the three-dimensional display cover 200 that is positioned outside the periphery of the display 140. As such, touch input provided by the user's finger 104 touching the peripheral portion 230 of the three-dimensional display cover 200 cannot be detected by the display 140.

As shown, the three-dimensional display cover 200 can have a shape corresponding to a dome. It should be understood, however, that the three-dimensional display cover can have any suitable shape. For instance, in some embodiments, the central portion 220 of the three-dimensional display cover 200 can be flat. Alternatively, or additionally, the peripheral portion 230 of the three-dimensional display cover 200 can be arcuate.

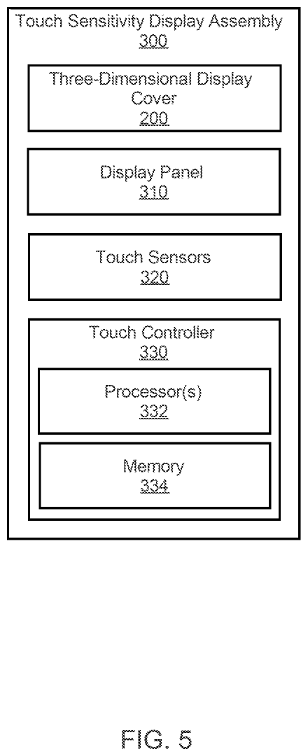

Referring now to FIG. 5, a block diagram of components of a touch sensitive display assembly 300 for use with a three-dimensional display cover is provided according to an embodiment of the present disclosure. For instance, in some embodiments, the touch sensitive display assembly 300 can include the three-dimensional display cover 200 discussed above with reference to FIG. 4. It should be understood, however, that the touch sensitive display assembly 300 can include any suitable three-dimensional display cover for a display of an electronic device.

The touch sensitive display assembly 300 can include a display panel 310. The display panel 310 can be at least partially positioned within the internal volume 210 (FIG. 4) of the three-dimensional display cover 200. In this manner, the three-dimensional display cover 200 can protect the display panel 310 from being damaged (e.g., scratched or cracked). The display panel 310 can include a plurality of different layers. It should be understood that the plurality of different layers can be stacked on top of one another to form the display panel 310. It should also be understood that the layers can include different materials and/or components. For instance, a display layer of the display panel 310 can include a plurality of pixels that can be controlled to display content for viewing by a user.

The touch sensitive display assembly 300 includes a plurality of touch sensors 320 for detecting touch input provided by the user touching the three-dimensional display cover 200 (FIG. 4). For instance, the plurality of touch sensors 320 includes a first plurality of touch sensors operable to detect a touch input provided by the user touching the central portion 220 (FIG. 4) of the three-dimensional display cover 200 and a second plurality of touch sensors operable to detect a touch input provided by the user touching the peripheral portion 230 (FIG. 4) of the three-dimensional display cover 200.

In some embodiments, one or more of the touch sensors 320 can include a capacitive sensor whose capacitance changes when touch input is provided at a location on the three-dimensional display cover 200 that corresponds to the capacitive sensor. It should be understood, however, that the touch sensors 320 can include any suitable type of sensor configured to detect touch input provided by the user touching the three-dimensional display cover 200.

The touch sensitive display assembly 300 includes a controller 330. The controller 330 can include one or more processors 332 and a memory 334. The processor(s) 332 can be communicatively coupled to the plurality of touch sensors 320. In this manner, the processor(s) can receive signals from the plurality of touch sensors 320. Furthermore, the memory 334 can store instructions 336 that, when executed by the processor(s) 332, cause the processor(s) 332 to process the signals received from the plurality of touch sensors 320 and perform one or more actions based on the location at which the touch input was provided. For instance, in some embodiments, the processor(s) 332 can be configured to update the content displayed by the display panel 310, specifically the display layer thereof.

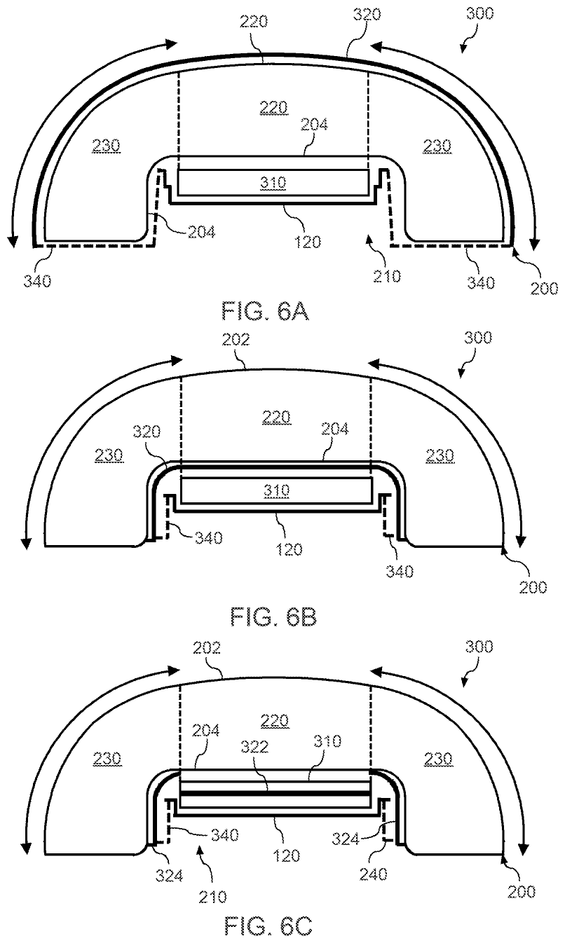

Referring now to FIG. 6A, a first embodiment of the touch sensitive display assembly 300 (FIG. 5) is provided according to the present disclosure. As shown, the plurality of touch sensors 320 can be positioned on the exterior surface 202 of the three-dimensional display cover 200. For instance, a first plurality of the touch sensors 320 can be positioned on a region of the exterior surface 202 of the three-dimensional display cover 200 that corresponds to the central portion 220 thereof. Additionally, a second plurality of the touch sensors 320 can be positioned on a region of the exterior surface 202 of the three-dimensional display cover 200 that corresponds to the peripheral portion 230 thereof. In this manner, touch input provided by the user touching any location (e.g., central portion 220 and peripheral portion 230) on the three-dimensional display cover 200 can be detected by the touch sensitive display assembly 300.

As shown, the touch sensitive display assembly 300 can include a plurality of conductors 340 (only one shown for simplicity). It should be understood that each of the conductors 340 can electrically couple the touch sensors 320 to the controller 330 (FIG. 5) of the touch sensitive display assembly 300. For instance, in some embodiments, the controller 330 can be disposed on the printed circuit board 120 of the wearable computing device 100 (FIG. 1). In alternative embodiments, the touch controller can be disposed on a separate printed circuit board.

It should be understood that a portion of the conductors 340 can be disposed on the interior surface 204 of the three-dimensional display cover 200. In some embodiments, an opaque material can be positioned on a region of the interior surface 204 of the three-dimensional display cover 200 that corresponds to the peripheral portion 230 of the three-dimensional display cover 200. Furthermore, the portion of the conductors 340 that is positioned on the interior surface 204 of the three-dimensional display cover 200 can be positioned on the opaque material. In this manner, the conductors 340 can be hidden from the user's view.

Referring now to FIG. 6B, a second embodiment of the touch sensitive display assembly 300 (FIG. 5) is provided according to the present disclosure. As shown, the plurality of touch sensors 320 can be positioned on the interior surface 204 of the three-dimensional display cover 200. For instance, a first plurality of the touch sensors 320 can be positioned on a region of the interior surface 204 that corresponds to the central portion 220 of the three-dimensional display cover 200. Additionally, a second plurality of the touch sensors 320 can be positioned on a region of the interior surface 204 that corresponds to the peripheral portion 230 thereof. In this manner, touch input provided by the user touching any location (e.g., central portion 220 and peripheral portion 230) on the three-dimensional display cover 200 can be detected by the touch sensitive display assembly 300.

It should be understood that a portion of the conductors 340 can be disposed on an interior surface 204 of the three-dimensional display cover 200. In some embodiments, an opaque material can be positioned on a region of the interior surface 204 of the three-dimensional display cover 200 that corresponds to the peripheral portion 230 of the three-dimensional display cover 200. Furthermore, the portion of the conductors 340 that is positioned on the interior surface 204 of the three-dimensional display cover 200 can be positioned on the opaque material. In this manner, the conductors 340 can be hidden from the user's view.

Referring now to FIG. 6C, a third embodiment of the touch sensitive display assembly 300 (FIG. 5) is provided according to the present disclosure. As shown, the plurality of touch sensors 320 (FIG. 5) can include a first plurality of touch sensors 322 disposed within a layer of the display panel 310. For instance, the first plurality of touch sensors 322 can be disposed within a touch layer of the display panel 310. In this manner, the first plurality of touch sensors 322 can detect touch input provided by the user touching a region of the exterior surface 202 of the three-dimensional display cover 200 that corresponds to the central portion 220 of the three-dimensional display cover 200.

The plurality of touch sensors 320 (FIG. 5) further include a second plurality of touch sensors 324 that are positioned on the interior surface 204 of the three-dimensional display cover 200. More particularly, the second plurality of touch sensors 324 are positioned on a region of the interior surface 204 that corresponds to the peripheral portion 230 of the three-dimensional display cover. In this manner, the second plurality of touch sensors 324 can detect touch input provided by the user touching a region of the exterior surface 202 of the three-dimensional display cover 200 that corresponds to the peripheral portion 230 of the three-dimensional display cover 200.

It should be understood that the conductors 340 electrically coupling the second plurality of touch sensors 324 to the controller 330 (FIG. 5) of the touch sensitive display assembly 300 can be disposed on the region of the interior surface 204 of the three-dimensional display cover 200 that corresponds to the peripheral portion 230 of the three-dimensional display cover 200. In some embodiments, an opaque material can be positioned on a region of the interior surface 204 of the three-dimensional display cover 200 that corresponds to the peripheral portion 230 of the three-dimensional display cover 200. Furthermore, the portion of the conductors 340 that is positioned on the interior surface 204 of the three-dimensional display cover 200 can be positioned on the opaque material. In this manner, the conductors 340 can be hidden from the user's view.

In some embodiments, the second plurality of touch sensors 324 can include sputtered touch sensors to facilitate coupling each of the conductors 340 between the printed circuit board 120 and a corresponding touch sensor of the second plurality of touch sensors 324. In alternative implementations, a silver paste can be used to couple each of the conductors 340 to the printed circuit board 120. Furthermore, in some embodiments, the printed circuit board 120 can be a flexible printed circuit board having a plurality of copper electrodes. In such embodiments, an end of each of the conductors 340 can be coupled to a corresponding copper electrode of the flexible printed circuit via the silver paste.

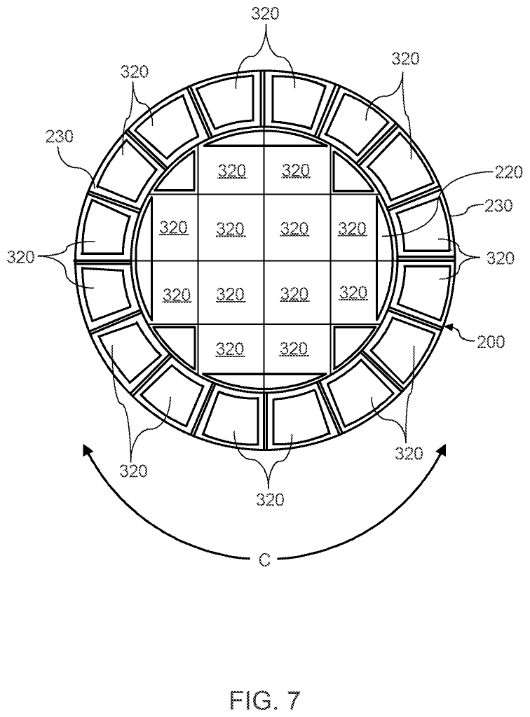

Referring now to FIG. 7, a plurality of the touch sensors 320 are shown disposed on the three-dimensional display cover 200 according to an embodiment of the present disclosure. As shown, a first plurality of the touch sensors 320 can be positioned on the central portion 220 of the three-dimensional display cover 200. Additionally, a second plurality of touch sensors 320 can be positioned on the peripheral portion 230 of the three-dimensional display cover 200. In some embodiments, a total number of touch sensors 320 positioned on the central portion 220 of the three-dimensional display cover 200 can be different as a total number of touch sensors 320 positioned on the peripheral portion 230 of the three-dimensional display cover 200. For instance, the total number of touch sensors 320 positioned on the central portion 220 of the three-dimensional display cover 200 can be greater than the total number of touch sensors 320 positioned on the peripheral portion 230 of the three-dimensional display cover 200. In alternative embodiments, the total number of touch sensors 320 positioned on the central portion 220 of the three-dimensional display cover 200 can be the same as the total number of touch sensors 320 positioned on the peripheral portion 230 of the three-dimensional display cover 200.

As shown, the second plurality of touch sensors 320 positioned on the peripheral portion 230 of the three-dimensional display cover 200 can be spaced apart from one another along a circumferential direction. Alternatively, or additionally, the second plurality of touch sensors 320 can, in some embodiments, fill less than the entirety of the peripheral portion 230 of the three-dimensional display cover 200. For instance, in some embodiments, there can be regions of the peripheral portion 230 of the three-dimensional display cover 200 that do not have touch sensors 320 attached thereto. In this manner, these regions of the peripheral portion 230 of the three-dimensional display cover 200 can be referred to as a “dead band area” in which touch inputs go undetected.

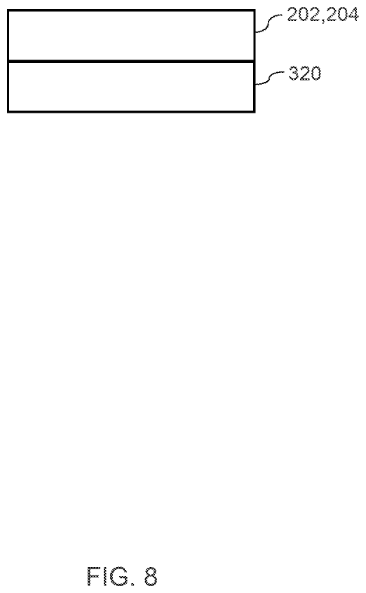

Referring now to FIG. 8, a cross-sectional view of a touch sensor 320 deposited on a surface of the three-dimensional display cover is provided according to an embodiment of the present disclosure. In some embodiments, the touch sensor 320 can be coupled to a surface (e.g., exterior surface 202, interior surface 204) via a deposition process. In some embodiments, the deposition process can include sputtering. It should be understood, however, that the touch sensor 320 can be coupled to the surface via any suitable chemical process.

Although the touch sensitive display assembly 300 (FIG. 5) has been discussed with reference to a three-dimensional display cover 200 (FIG. 4) for a display of a wearable computing device 100 (FIG. 1), it should be appreciated that the touch sensitive display assembly 300 is not intended to be limited in this manner. For instance, the touch sensitive display assembly 300 according to the present disclosure can be used with any electronic devices (e.g., smartphones, tablets, thermostats) that can accommodate a three-dimensional display cover.

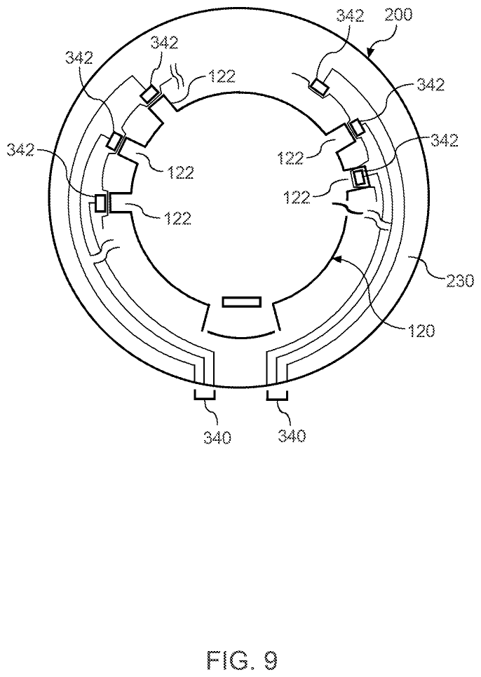

Referring now to FIG. 9, a connection between the printed circuit board 120 and each of the plurality of conductors 340 is shown according to an embodiment of the present disclosure. In some implementations, an end 342 of each of the conductors 340 can be deposited on the printed circuit board 120. For instance, in some implementations, the printed circuit board 120 can include a plurality of connection points 122, and the end 342 of each of the conductors 340 can be deposited on a corresponding connection point of the plurality of connection points 122. In some implementations, each of the plurality of connection points 122 can include a copper material. Furthermore, in some implementations, the end 342 of each of the plurality of conductors 340 can be deposited on corresponding connection point of the connection points 122 via a silver paste.

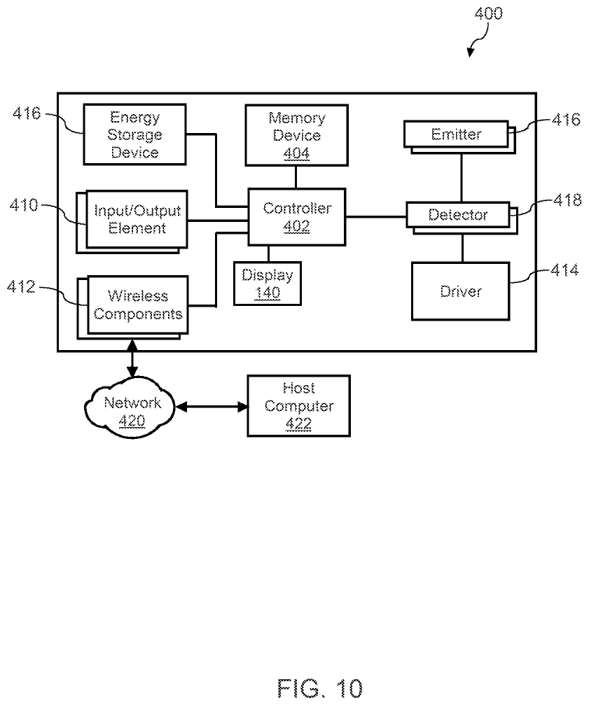

Referring now to FIG. 10, components of an example computing system 400 of the wearable computing device 100 that can be utilized in accordance with various embodiments are illustrated. In particular, as shown, the computing system 400 may also include at least one controller 402. Moreover, in an embodiment, the controller(s) 402 can be a central processing unit (CPU) or graphics processing unit (GPU) for executing instructions that can be stored in a memory device 404, such as flash memory or DRAM, among other such options. For example, in an embodiment, the memory device 404 may include RAM, ROM, FLASH memory, or other non-transitory digital data storage, and may include a control program comprising sequences of instructions which, when loaded from the memory device 404 and executed using the controller(s) 402, cause the controller(s) 402 to perform the functions that are described herein.

The computing system 400 can include many types of memory, data storage, or computer-readable media, such as data storage for program instructions for execution by the controller or any suitable processor. The same or separate storage can be used for images or data, a removable memory can be available for sharing information with other devices, and any number of communication approaches can be available for sharing with other devices. In addition, as shown, the computing system 400 includes the display 140, which may be a touch screen, organic light emitting diode (OLED), or liquid crystal display (LCD), although devices might convey information via other means, such as through audio speakers, projectors, or casting the display or streaming data to another device, such as a mobile phone, wherein an application on the mobile phone displays the data.

The computing system 400 can include one or more wireless networking components 412 operable to communicate with one or more electronic devices within a communication range of a particular wireless channel. The wireless channel can be any appropriate channel used to enable devices to communicate wirelessly, such as Bluetooth, cellular, NFC, Ultra-Wideband (UWB), or Wi-Fi channels. It should be understood that the computing system 400 can have one or more conventional wired communications connections as known in the art.

The computing system 400 also includes one or more power components 408, operable to be recharged through conventional plug-in approaches. In some embodiments, the computing system 400 can also include at least one additional I/O device 410 able to receive conventional input from a user. This conventional input can include, for example, a push button, touch pad, touch screen, wheel, joystick, keyboard, mouse, keypad, or any other such device or element whereby a user can input a command to the computing system 400. In some embodiments, the I/O device(s) 410 can be connected by a wireless infrared or Bluetooth or other link as well in some embodiments. In some embodiments, the computing system 400 can include a microphone or other audio capture element that accepts voice or other audio commands. In some embodiments, the I/O device(s) 410 can include one or more electrodes, optical sensors, barometric sensors (e.g., altimeter, etc.), and the like.

The computing system 400 can include a driver 414 and at least some combination of one or more emitters 416 and one or more detectors 418 for measuring data for one or more metrics of a human body, such as for a person wearing the wearable computing device 100. In some embodiments, for example, this may involve at least one imaging element, such as one or more cameras that are able to capture images of the surrounding environment and that are able to image a user, people, or objects in the vicinity of the device. The image capture element can include any appropriate technology, such as a CCD image capture element having a sufficient resolution, focal range, and viewable area to capture an image of the user when the user is operating the device. Further image capture elements may also include depth sensors. Methods for capturing images using a camera element with a computing device are well known in the art and will not be discussed herein in detail. It should be understood that image capture can be performed using a single image, multiple images, periodic imaging, continuous image capturing, image streaming, etc. Further, the computing system 400 can include the ability to start and/or stop image capture, such as when receiving a command from a user, application, or other device.

The emitters 416 and the detectors 418 may also be capable of being used, in one example, for obtaining optical photoplethysmogram (PPG) measurements. Some PPG technologies rely on detecting light at a single spatial location, or adding signals taken from two or more spatial locations. Both of these approaches result in a single spatial measurement from which the heart rate (HR) estimate (or other physiological metrics) can be determined. In some embodiments, a PPG device employs a single light source coupled to a single detector (i.e., a single light path). Alternatively, a PPG device may employ multiple light sources coupled to a single detector or multiple detectors (i.e., two or more light paths). In other embodiments, a PPG device employs multiple detectors coupled to a single light source or multiple light sources (i.e., two or more light paths). In some cases, the light source(s) may be configured to emit one or more of green, red, infrared (IR) light, as well as any other suitable wavelengths in the spectrum (such as long IR for metabolic monitoring). For example, a PPG device may employ a single light source and two or more light detectors each configured to detect a specific wavelength or wavelength range. In some cases, each detector is configured to detect a different wavelength or wavelength range from one another. In other cases, two or more detectors are configured to detect the same wavelength or wavelength range. In yet another case, one or more detectors configured to detect a specific wavelength or wavelength range different from one or more other detectors). In embodiments employing multiple light paths, the PPG device may determine an average of the signals resulting from the multiple light paths before determining an HR estimate or other physiological metrics.

Moreover, in an embodiment, the emitters 416 and detectors 418 may be coupled to the controller 402 directly or indirectly using driver circuitry by which the controller 402 may drive the emitters 416 and obtain signals from the detectors 418. The host computer 422 can communicate with the wireless networking components 412 via the one or more networks 420, which may include one or more local area networks, wide area networks, UWB, and/or internetworks using any of terrestrial or satellite links. In some embodiments, the host computer 422 executes control programs and/or application programs that are configured to perform some of the functions described herein.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A touch sensitive display assembly comprising:
a three-dimensional display cover defining an internal volume, the three-dimensional display cover including a central portion and peripheral portion, the peripheral portion extending around a periphery of the internal volume;
a display panel positioned within the internal volume;
a first plurality of touch sensors, each of the first plurality of touch sensors operable to detect a touch input provided at a central portion of the three-dimensional display cover; and
a second plurality of touch sensors, each of the second plurality of touch sensors operable to detect a touch input provided at the peripheral portion of the three-dimensional display cover.

2. The touch sensitive display assembly of claim 1, wherein each of the second plurality of touch sensors is positioned on the peripheral portion of the three-dimensional display cover.

3. The touch sensitive display assembly of claim 2, wherein the second plurality of touch sensors are spaced apart from one another along a circumferential direction.

4. The touch sensitive display assembly of claim 2, wherein each of the first plurality of touch sensors is included within a first layer of a plurality of layers of the display panel.

5. The touch sensitive display assembly of claim 2, wherein each of the first plurality of touch sensors is positioned on the central portion of the three-dimensional display cover.

6. The touch sensitive display assembly of claim 5, further comprising:
a controller;
a first plurality of conductors, each of the first plurality of conductors electrically coupling the controller to a corresponding touch sensor of the first plurality of touch sensors; and
a second plurality of conductors, each of the second plurality of conductors electrically coupling the controller to a corresponding touch sensor of the second plurality of touch sensors.

7. The touch sensitive display assembly of claim 6, wherein:
at least a portion of the first plurality of conductors and the second plurality of conductors is disposed on the peripheral portion of the three-dimensional display cover.

8. The touch sensitive display assembly of claim 5, wherein at least one of the first plurality of touch sensors or the second plurality of touch sensors is deposited on a surface of the three-dimensional display cover.

9. A wearable computing device comprising:
a housing;
a three-dimensional display cover positioned on the housing and defining an internal volume, the three-dimensional display cover having a central portion and a peripheral portion extending around a periphery of the internal volume; and
a touch sensitive display assembly comprising:
a three-dimensional display cover positioned on the housing and defining an internal volume, the three-dimensional display cover having a central portion and a peripheral portion, the peripheral portion extending around a periphery of the internal volume;
a display panel positioned within the internal volume;
a first plurality of touch sensors, each of the first plurality of touch sensors operable to detect a touch input provided at a central portion of the three-dimensional display cover; and
a second plurality of touch sensors, each of the second plurality of touch sensors operable to detect a touch input provided at the peripheral portion of the three-dimensional display cover.

10. The wearable computing device of claim 9, wherein each of the second plurality of touch sensors is positioned on the peripheral portion of the three-dimensional display cover.

11. The wearable computing device of claim 10, wherein each of the first plurality of touch sensors is positioned on the central portion of the three-dimensional display cover.

12. The wearable computing device of claim 10, wherein each of the first plurality of touch sensors is included within a first layer of a plurality of layers of the display panel.

13. The wearable computing device of claim 10, wherein each of the second plurality of touch sensors is positioned on a region of an interior surface of the three-dimensional display cover that corresponds to the peripheral portion of the three-dimensional display cover.

14. The wearable computing device of claim 13, wherein the touch sensitive display assembly further comprises:
a plurality of conductors, each of the plurality of conductors coupling a corresponding touch sensor of the second plurality of touch sensors to a flexible printed circuit board disposed within a cavity defined by the housing of the wearable computing device.

15. The wearable computing device of claim 14, wherein the touch sensitive display assembly further includes:
an opaque material positioned between the interior surface of the three-dimensional display cover and the plurality of conductors.

16. The wearable computing device of claim 9, wherein:
the three-dimensional display cover defines a circumferential direction; and
the second plurality of touch sensors are spaced apart from one another along the circumferential direction.

17. The wearable computing device of claim 9, wherein the three-dimensional display cover comprises a glass material.

18. The wearable computing device of claim 9, wherein the central portion of the three-dimensional display cover is flat and the peripheral portion of the three-dimensional display cover is arcuate.

19. The wearable computing device of claim 9, wherein a total number of touch sensors included in the first plurality of touch sensors is different than a total number of touch sensors included in the second plurality of touch sensors.

20. The wearable computing device of claim 9, wherein at least one of the first plurality of touch sensors or the second plurality of touch sensors includes a capacitive sensor.
